(19) United States
(12) Patent Application Publication
(10) Pub. No.: US 2007/0154360 A1
(43) Pub. Date: Jul. 5, 2007

(54) Microchannel apparatus comprising a platinum aluminide layer and chemical processes using the apparatus

(75) Inventors: Francis P. Daly, Delaware, OH (US); Richard Long, New Albany, OH (US); Barry L. Yang, Dublin, OH (US); Terry Mazanec, Solon, OH (US); Frederick S. Pettit, Pittsburgh, PA (US)

Correspondence Address: FRANK ROSENBERG, P.O. BOX 29230, SAN FRANCISCO, CA, 94129-0230, US

(73) Assignee: VELOCYS INC., Plain City, OH (US)

(21) Appl. No.: 11/549,612

(22) Filed: Oct. 13, 2006

Related U.S. Application Data
(60) Provisional application No. 60/726,733, filed on Oct. 13, 2005.

(51) Int. Cl. B01J 19/00

(52) U.S. Cl. 422/130

(57) ABSTRACT

The invention describes microchannel apparatus and catalysts that contain a layer of a platinum aluminide. The invention includes chemical processes conducted through apparatus described in the specification.

### RELATED APPLICATIONS

This application claims priority to U.S. Patent Application No. 60/726,733, filed Oct. 13, 2005.

### GOVERNMENT RIGHTS

This invention was made with Government support under Contract DE-FC36-04-GO14154. The Government has certain rights in this invention.

### FIELD OF THE INVENTION

This invention relates to microchannel apparatus, catalysts and methods of making same. The invention also relates to chemical reactions and microchannel chemical reactors.

### INTRODUCTION

In recent years there has been tremendous academic and commercial interest in microchannel devices. This interest has arisen due to the advantages from microtechnology including reduced size, increased productivity, the ability to size systems of any desired capacity (i.e., “number-up”), increased heat transfer, and increased mass transfer. A review of some of the work involving microreactors (a subset of microchannel apparatus) has been provided by Gavrilidis et al., “Technology And Applications Of Microengineered Reactors,” Trans. IChemE, Vol. 80, Part A, pp. 3-30 (January 2002).

Microchannel apparatus can be made of a variety of materials including ceramics, plastics, and metals. In many applications, process channels in microchannel apparatus require a coating or coatings over the structural material. The coatings can serve purposes such as absorption, adsorption, surface passivation, chemical and biochemical compatibility, corrosion protection, surface wettability for tailored micro-fluidics and catalysis. In some cases, microchannels are slurry coated or sol coated; for example, an oxide coat applied to a ceramic honeycomb. In some cases, sheets of a material are coated and then assembled and bonded to form a multilayer microchannel device.

Since one focus of the present invention includes aluminide coatings, reference can be made to early work described by LaCroix in U.S. Pat. No. 3,944,505. This patent describes a catalytic device made of a stack of expanded metal sheets (such as Inconel). The metal sheets carry a layer of a nickel or cobalt aluminide and a layer of alpha alumina on the nickel or cobalt aluminide, and a catalytic surface on the nickel or cobalt aluminide. LaCroix did not describe how the aluminide layer was formed on the sheets, nor did LaCroix provide any data describing the aluminide layer.

Methods of forming aluminide coatings are well known and have been utilized commercially for coating certain jet engine parts. Methods of making aluminide coatings from aluminum halides are described in, for example, U.S. Pat. Nos. 3,486,927 and 6,332,926.

There have been attempts to apply aluminide coatings on interior channels of gas turbine airfoils. Rigney et al. in U.S. Pat. No. 6,283,714 reported coating internal cooling passages of turbine blades with an aluminum coating using a slurry/pack process. Rigney et al. also stated that an aluminum halide gas could be passed through the cooling passages at high temperature so that an aluminum coating about 0.002 inch (50 μm) thick may be deposited in about 4 to 8 hours. Pfaendter et al. in U.S. Pat. No. 6,332,926 also suggests flowing an aluminum-coating precursor to deposit aluminum onto an internal airfoil surface.

Several patents have described airfoils having aluminide layers containing platinum, such as U.S. Pat. No. 6,291,014, U.S. Pat. No. 5,856,027, or U.S. Pat. No. 5,716,720, which are incorporated herein by reference. Gleeson et al. also reported improved oxidation resistance of platinum containing aluminides with specific phases and compositions in US Published Patent Applications Ser. Nos. 20060210825, 20060127695, and 20040229075. However, there has been no report on coating internal channels with platinum containing aluminides. Platinum deposition is commonly done by electrolytic plating or physical vapor deposition (PVD) such as sputtering or e-beam vaporization. Electrolytic plating is unsuitable for internal channels, particularly microchannels and channels with bends, turns or other geometry complexity, because a counter electrode needs to be placed inside each channel. PVD is unsuitable for internal channels because of its line-of-sight limitation.

Howard et al. in U.S. Pat. No. 5,928,725 entitled “Method and Apparatus for Gas Phase Coating Complex Internal Surfaces of Hollow Articles,” reviewed prior art methods of gas phase coating for coating internal surfaces but remarked that the prior art methods were ineffective for coating multiple gas passages of modern airfoils and result in non-uniform internal coatings. In the process described in this patent, the coating gas flow rate is controlled to a different rate into at least two channels. Howard et al. state that a coating mixture including aluminum powder, aluminum oxide and aluminum flouride could be heated to deliver a coating gas. This improved method was reported to result in an aluminide coating thickness of 1.5 mils±1.0 mil.

As described below, the present invention provides novel microchannel apparatus having improved coatings and methods of making improved coatings. The invention also includes methods of conducting chemical processes through microchannel devices with coated microchannels.

### SUMMARY OF THE INVENTION

In a first aspect, the invention provides a microchannel reactor or separator, comprising: a microchannel defined by at least one microchannel wall; and a layer of platinum aluminide disposed over the at least one microchannel wall. In this aspect as well as the next aspect, it is important to recognize the character of the invention as a reactor or separator—these functions are integral to the definition of the invention. Preferably the reactor or separator further comprises a layer of alumina disposed over the layer of aluminide; and a catalytic material disposed over the layer of alumina. The reactor or separator may include a manifold that is connected to at least two microchannels, wherein the manifold comprises a manifold wall that is coated with a platinum aluminide layer. In a preferred embodiment, the reactor or separator is made by laminating together sheets and the layer of platinum aluminide is a post-assembly coating. As with all aspects of the invention, the invention can be further described in conjunction with any details from the Detailed Description. Furthermore, as with all aspects of the invention, the invention includes methods of making the apparatus and methods of conducting a chemical process in the apparatus. For example, the invention includes a method of conducting a chemical reaction or separating a mixture comprising at least two components in the above-described reactor or separator, comprising either:

(a) wherein the reactor or separator is a reactor (and preferably wherein the reactor further comprises a layer of alumina disposed over the layer of aluminide; and a catalytic material disposed over the layer of alumina), and comprising a step of passing a reactant into the microchannel and reacting the reactant in the microchannel to form at least one product; or

(b) wherein the reactor or separator is a separator and comprising a step of passing a fluid comprising at least two components into the microchannel, preferentially separating at least one of the at least two components within the microchannel.

In another aspect, the invention provides a method of making a microchannel reactor or separator. This method includes stacking patterned sheets to form a stacked set of patterned sheets with interior passages; bonding the set of patterned sheets to form a laminated device; and subsequently, applying a layer comprising Pt into interior passages of the laminated device. Simultaneous with, or subsequent to, the step of applying a layer comprising Pt, aluminum is deposited and a layer of platinum aluminide is formed. Preferably, the step of forming the layer of platinum aluminide is accompanied by a simultaneous and/or subsequent heat treatment. The article with the layer of platinum aluminide is typically oxidized to form a surface oxide layer. In some preferred embodiments, a catalyst material (typically, initially in the form of a catalyst precursor) is applied to the layer of surface oxide.

In another aspect, the invention provides a method of forming a catalyst comprising providing a metal support (such as a metal foam or finned support) applying a layer comprising platinum onto the support. Simultaneous with, or subsequent to, the step of applying a layer comprising Pt, aluminum is deposited and a layer of platinum aluminide is formed. Preferably, the step of forming the layer of platinum aluminide is accompanied by a simultaneous and/or subsequent heat treatment. The article with the layer of platinum aluminide is typically oxidized to form a surface oxide layer. In some preferred embodiments, a catalyst material (typically, initially in the form of a catalyst precursor) is applied to the layer of surface oxide.

In a further aspect, the invention provides microchannel apparatus, comprising: at least two parallel microchannels, each of which is contiguous for at least 1 cm; a manifold connecting the at least two microchannels; wherein the manifold comprises a platinum aluminide coating.

Many aspects of the present invention include passage of gaseous aluminum compounds over metal surfaces (especially a metal wall of a microchannel) and simultaneously or subsequently reacting with a metal in the substrate to form a surface layer of metal aluminide—this process is termed aluminization, perhaps more accurately, aluminidization. Conditions for aluminidization are conventionally known for jet engine parts, and the conventional steps are not described here.

The invention also includes methods for catalytic chemical conversion, such method comprising flowing a reactant fluid composition into a microchannel, wherein a catalyst composition is present in the microchannel (on a microchannel wall or elsewhere within the microchannel), and reacting the reactant fluid composition to form a desired product (or products) in the microchannel. The invention further includes methods for catalytic chemical conversion comprising contacting at least one reactant with an inventive catalyst.

Various embodiments of the invention can provide various advantages. An aluminide layer serves as an aluminum reservoir for self healing if there is any damage to the overlying alumina layer. The platinum aluminide layer may also reduce coke formation (in processes susceptible to coke formation) and reduce metal dusting. The corrosive power of a chemical reaction often depends on both the temperature and the chemical nature of the fluid to be processed. Alumina is both thermally and chemically stable, and thus superior to many other materials.

Glossary of Terms Used

“Metal aluminide” refers to a metallic material containing 10% or more Metal and 5%, more preferably 10%, or greater Aluminum (Al) with the sum of Metal and Al being 50% or more. These percentages refer to mass percents. Preferably, a metal aluminide contains 50% or more Metal and 10% or greater Al with the sum of Ni, Pt and Al being 80% or more. In embodiments in which Metal and Al have undergone significant thermal diffusion, it is expected that the composition of a Metal-Al layer will vary gradually as a function of thickness so that there may not be a distinct line separating the Metal-Al layer from an underlying metallic alloy substrate. The term “aluminide” is used synonamously with metal aluminide. A phase diagram of the NiAl system is shown in FIG. 2 of U.S. Pat. No. 5,716,720.

A preferred metal aluminide is platinum aluminide (PtAl). “Platinum aluminide” refers to a material containing 8% or more platinum and 2% or greater Al with the sum of platinum and Al being 20% or more. These percentages refer to mass percents. Preferably, a platinum aluminide contains 8% or more, preferably 15% or more Pt and 5% or greater Al with the sum of Pt and Al being 40% or more, and in some embodiments 6% or greater Al with the sum of Pt and Al being 60% or more. Pt aluminide is a metal alloy and contains substantially no oxygen, although the microchannels can (and typically do) contain oxygen in other layers.

A “catalyst material” is a material that catalyzes a desired reaction. It is not alumina. A catalyst material “disposed over” a layer can be a physically separate layer (such as a sol-deposited layer) or a catalyst material disposed within a porous, catalyst support layer. “Disposed onto” or “disposed over” mean directly on or indirectly on with intervening layers. In some preferred embodiments, the catalyst material is directly on a thermally-grown alumina layer.

A “catalyst metal” is the preferred catalyst material and is a material in metallic form that catalyzes a desired reaction. Catalyst metals can exist as fully reduced metals, or as mixtures of metal and metal oxides, depending on the conditions of treatment. Particularly preferred catalyst metals are Pd, Rh and Pt.

A “complex microchannel” is in apparatus that includes one or more of the following characteristics: at least one contiguous microchannel has a turn of at least 45°, in some embodiments at least 90°, in some embodiments a u-bend; a length of 50 cm or more, or a length of 20 cm or more along with a dimension of 2 mm or less, and in some embodiments a length of 50-500 cm; at least one microchannel that splits into at least 2 sub-microchannels in parallel, in some embodiments 2 to 4 sub-channels in parallel; at least 2 adjacent channels, having an adjacent length of at least one cm that are connected by plural orifices along a common microchannel wall where the area of orifices amounts to 20% or less of the area of the microchannel wall in which the orifices are located and where each orifice is 1.0 mm² or smaller, in some embodiments 0.6 mm² or smaller, in some embodiments 0.1 mm² or smaller—this is a particularly challenging configuration because a coating should be applied without clogging the holes; or at least two, in some embodiments at least 5, parallel microchannels having a length of at least 1 cm, have openings to an integral manifold, where the manifold includes at least one dimension that is no more than three times the minimum dimension of the parallel microchannels (for example, if one of the parallel microchannels had a height of 1 mm (as the smallest dimension in the set of parallel microchannels), then the manifold would possess a height of no more than 3 mm). An integral manifold is part of the assembled device and is not a connecting tube. A complex microchannel is one type of interior microchannel.

A “contiguous microchannel” is a microchannel enclosed by a microchannel wall or walls without substantial breaks or openings—meaning that openings (if present) amount to no more than 20% (in some embodiments no more than 5%, and in some embodiments without any openings) of the area of the microchannel wall or walls on which the opening(s) are present.

An “interior microchannel” is a microchannel within a device that is surrounded on all sides by a microchannel wall or walls except for inlets and outlets, and, optionally, connecting holes along the length of a microchannel such as a porous partition or orifices such as connecting orifices between a fuel channel and an oxidant channel. Since it is surrounded by walls, it is not accessible by conventional lithography, conventional physical vapor deposition, or other surface coating techniques with line-of-sight limitation. In some embodiments, the interior microchannel is an interior of a complex microchannel.

An “insert” is a component that can be inserted into a channel either before or after assembly of the apparatus.

A “manifold” is a header or footer that connects plural microchannels and is integral with the apparatus.

“Ni-based” alloys are those alloys comprising at least 30%, prefearbly at least 45% Ni, more preferably at least 50% (by mass). In some preferred embodiments, these alloys also contain at least 5%, preferably at least 10% Cr.

A “post-assembly” coating is applied onto three dimensional microchannel apparatus. This is either after a laminating step in a multilayer device made by laminating sheets or after manufacture of a manufactured multi-level apparatus such as an apparatus in which microchannels are drilled into a block. This “post-assembly” coating can be contrasted with apparatus made by processes in which sheets are coated and then assembled and bonded or apparatus made by coating a sheet and then expanding the sheet to make a three-dimensional structure. For example, a coated sheet that is then expanded may have uncoated slit edges. Uncoated surfaces of all types, such as slit edges, can undergo corrosion or reaction under reaction conditions. Thus, it is advantageous to coat the device after assembly to protect all of the internal surface against corrosion. The post-assembly coating provides advantages such as crack-filling and ease of manufacture. Additionally, the aluminide or other coating could interfere with diffusion bonding of a stack of coated sheets and result in an inferior bond since aluminide is not an ideal material for bonding a laminated device and may not satisfy mechanical requirements at high temperature. Whether an apparatus is made by a post-assembly coating is detectable by observable characteristics such as gap-filling, crack-filling, elemental analysis (for example, elemental composition of sheet surfaces versus bonded areas) Typically, these characterisitics are observed by optical microscopy, electron microscopy or electron microscopy in conjunction with elemental analysis. Thus, for a given apparatus, there is a difference between pre-assembled and post-assembled coated devices, and an analysis using well-known analytical techniques can establish whether a coating was applied before or after assembly (or manufacture in the case of drilled microchannels) of the microchannel device.

A “separator” is a type of chemical processing apparatus that is capable of separating a component or components from a fluid. For example, a device containing an adsorbent, distillation or reactive distillation apparatus, etc.

### BRIEF DESCRIPTION OF THE FIGURES

FIG. 1 shows the uptake by the ¼″ tubes as a function of time with solutions of different Pt concentrations.

FIG. 2 gives the uptake curve with a 2% Pt solution on ⅛″ tubes.

### DESCRIPTION OF THE INVENTION

Microchannel Apparatus

Microchannel reactors are characterized by the presence of at least one reaction channel having at least one dimension (wall-to-wall, not counting catalyst) of 1.0 cm or less, preferably 2.0 mm or less (in some embodiments about 1.0 mm or less) and greater than 100 nm (preferably greater than 1 μm), and in some embodiments 50 to 500 μm. A reaction channel is a channel containing a catalyst. Microchannel apparatus is similarly characterized, except that a catalyst-containing reaction channel is not required. Both height and width are substantially perpendicular to the direction of flow of reactants through the reactor. Microchannels are also defined by the presence of at least one inlet that is distinct from at least one outlet—microchannels are not merely channels through zeolites or mesoporous materials. The height and/or width of a reaction microchannel is preferably about 2 mm or less, and more preferably 1 mm or less. The length of a reaction channel is typically longer. Preferably, the length of a reaction channel is greater than 1 cm, in some embodiments greater than 50 cm, in some embodiments greater than 20 cm, and in some embodiments in the range of 1 to 100 cm. The sides of a microchannel are defined by reaction channel walls. These walls are preferably made of a hard material such as a ceramic, an iron based alloy such as steel, or a Ni—, Co— or Fe-based superalloy such as monel. The choice of material for the walls of the reaction channel may depend on the reaction for which the reactor is intended. In some embodiments, the reaction chamber walls are comprised of a stainless steel or Inconel® which is durable and has good thermal conductivity. The alloys should be low in sulfer, and in some embodiments are subjected to a desulferization treatment prior to formation of an aluminide. Typically, reaction channel walls are formed of the material that provides the primary structural support for the microchannel apparatus. The microchannel apparatus can be made by known methods (except for the coatings and treatments described herein), and in some preferred embodiments are made by laminating interleaved plates (also known as “shims”), and preferably where shims designed for reaction channels are interleaved with shims designed for heat exchange. Of course, as is conventionally known, “reactors” or “separators” do not include jet engine parts. In preferred embodiments, microchannel apparatus does not include jet engine parts. Some microchannel apparatus includes at least 10 layers laminated in a device, where each of these layers contain at least 10 channels; the device may contain other layers with fewer channels.

Microchannel reactors preferably include a plurality of microchannel reaction channels and a plurality of adjacent heat exchange microchannels. The plurality of microchannel reaction channels may contain, for example, 2, 10, 100, 1000 or more channels. In preferred embodiments, the microchannels are arranged in parallel arrays of planar microchannels, for example, at least 3 arrays of planar microchannels. In some preferred embodiments, multiple microchannel inlets are connected to a common header and/or multiple microchannel outlets are connected to a common footer. During operation, the heat exchange microchannels (if present) contain flowing heating and/or cooling fluids. Non-limiting examples of this type of known reactor usable in the present invention include those of the microcomponent sheet architecture variety (for example, a laminate with microchannels) exemplified in U.S. Pat. Nos. 6,200,536 and 6,219,973 (both of which are hereby incorporated by reference). Performance advantages in the use of this type of reactor architecture for the purposes of the present invention include their relatively large heat and mass transfer rates, and the substantial absence of any explosive limits. Microchannel reactors can combine the benefits of good heat and mass transfer, excellent control of temperature, residence time and minimization of by-products. Pressure drops can be low, allowing high throughput and the catalyst can be fixed in a very accessible form within the channels eliminating the need for separation. Furthermore, use of microchannel reactors can achieve better temperature control, and maintain a relatively more isothermal profile, compared to conventional systems. In some embodiments, the reaction microchannel (or microchannels) contains a bulk flow path. The term “bulk flow path” refers to an open path (contiguous bulk flow region) within the reaction chamber. A contiguous bulk flow region allows rapid fluid flow through the reaction chamber without large pressure drops. In some preferred embodiments there is laminar flow in the bulk flow region. Bulk flow regions within each reaction channel preferably have a cross-sectional area of 5×10⁻⁸ to 1×10⁻² m², more preferably 5×10⁻⁷ to 1×10⁻⁴ m². The bulk flow regions preferably comprise at least 5%, more preferably at least 50% and in some embodiments, 30-80% of either 1) the internal volume of the reaction chamber, or 2) a cross-section of the reaction channel.

In many preferred embodiments, the microchannel apparatus contains multiple microchannels, preferably groups of at least 5, more preferably at least 10, parallel channels that are connected in a common manifold that is integral to the device (not a subsequnetly-attached tube) where the common manifold includes a feature or features that tend to equalize flow through the channels connected to the manifold. Examples of such manifolds are described in U.S. patent application Ser. No. 10/695,400, filed Oct. 27, 2003 which is incorporated herein as if reproduced in full below. In this context, “parallel” does not necessarily mean straight, rather that the channels conform to each other. In some preferred embodiments, a microchannel device includes at least three groups of parallel microchannels wherein the channel within each group is connected to a common manifold (for example, 4 groups of microchannels and 4 manifolds) and preferably where each common manifold includes a feature or features that tend to equalize flow through the channels connected to the manifold. An aluminide coating can be formed in a group of connected microchannels by passing an aluminum-containing gas into a manifold, typically, the manifold will also be coated.

Heat exchange fluids may flow through heat transfer microchannels adjacent to process channels (preferably reaction microchannels), and can be gases or liquids and may include steam, liquid metals, or any other known heat exchange fluids—the system can be optimized to have a phase change in the heat exchanger. In some preferred embodiments, multiple heat exchange layers are interleaved with multiple reaction microchannels. For example, at least 10 heat exchangers interleaved with at least 10 reaction microchannels and preferably there are 10 layers of heat exchange microchannel arrays interfaced with at least 10 layers of reaction microchannels. Each of these layers may contain simple, straight channels or channels within a layer may have more complex geometries.

While simple microchannels can be utilized, the invention has particularly strong advantages for apparatus with complex microchannel geometries. In some preferred embodiments, the microchannel apparatus includes one or more of the following characteristics: at least one contiguous microchannel has a turn of at least 45°, in some embodiments at least 90°, in some embodiments a u-bend; a length of 50 cm or more, or a length of 20 cm or more along with a dimension of 2 mm or less, and in some embodiments a length of 50-200 cm; at least one microchannel that splits into at least 2 sub-microchannels in parallel, in some embodiments 2 to 4 sub-channels in parallel; at least 2 adjacent channels, having an adjacent length of at least one cm that are connected by plural orifices along a common microchannel wall where the area of orifices amounts to 20% or less of the area of the microchannel wall in which the orifices are located and where each orifice is 1.0 mm² or smaller, in some embodiments 0.6 mm² or smaller, in some embodiments 0.1 mm² or smaller—this is a particularly challenging configuration because a coating should be applied without clogging the holes; or at least two, in some embodiments at least 5, parallel microchannels having a length of at least 1 cm, have openings to an integral manifold, where the manifold includes at least one dimension that is no more than three times the minimum dimension of the parallel microchannels (for example, if one of the parallel microchannels had a height of 1 mm (as the smallest dimension in the set of parallel microchannels), then the manifold would possess a height of no more than 3 mm). An integral manifold is part of the assembled device and is not a connecting tube. A complex microchannel is one type of interior microchannel. In some apparatus, a microchannel contains a u-bend which means that, during operation, flow (or at least a portion of the flow) passes in opposite directions within a device and within a continguous channel (note that a contiguous channel with a u-bend includes split flows such as a w-bend, although in some preferred embodiments all flow within a microchannel passes through the u-bend and in the opposite direction in a single microchannel).

In some embodiments, the inventive apparatus (or method) includes a catalyst material. The catalyst may define at least a portion of at least one wall of a bulk flow path. In some preferred embodiments, the surface of the catalyst defines at least one wall of a bulk flow path through which the mixture passes. During operation, a reactant composition flows through the microchannel, past and in contact with the catalyst. In some preferred embodiments, a catalyst is provided as an insert that can be inserted into (or removed from) each channel in a single piece; of course the insert would need to be sized to fit within the microchannel. In some embodiments, the height and width of a microchannel defines a cross-sectional area, and this cross-sectional area comprises a porous catalyst material and an open area, where the porous catalyst material occupies 5% to 95% of the cross-sectional area and where the open area occupies 5% to 95% of the cross-sectional area. In some embodiments, the open area in the cross-sectional area occupies a contiguous area of 5×10⁻⁸ to 1×10⁻² m². In some embodiments, a porous catalyst (not including void spaces within the catalyst) occupies at least 60%, in some embodiments at least 90%, of a cross-sectional area of a microchannel. Alternatively, catalyst can substantially fill the cross-sectional area of a microchannel (a flow through configuration). In another alternative, catalyst can be provided as a coating (such as a washcoat) of material within a microchannel reaction channel or channels. The use of a flow-by catalyst configuration can create an advantageous capacity/pressure drop relationship. In a flow-by catalyst configuration, fluid preferably flows in a gap adjacent to a porous insert or past a wall coating of catalyst that contacts the microchannel wall (preferably the microchannel wall that contacts the catalyst is in direct thermal contact with a heat exchanger (preferably a microchannel heat exchanger), and in some embodiments a coolant or heating stream contacts the opposite side of the wall that contacts the catalyst).

Other Substrates

In preferred embodiments, the inventive apparatus, catalysts or methods contain or use an aluminide coating on an interior microchannel. In preferred embodiments, the invention includes an aluminide layer, an alumina layer and a catalyst material coated onto an interior microchannel wall. However, in some embodiments, the aluminide-coated microchannel contains a “porous catalyst material” as described below. For example, a porous catalyst material such as a porous metal foam could be coated with an aluminide layer to form a catalyst. In other embodiments, the invention includes a catalyst (or method of making a catalyst) in which an aluminide layer is formed on a substrate (catalyst support) other than a microchannel wall. Thus, in some embodiments, the invention includes a substrate, an aluminide coating over the substrate, and a catalyst material over the aluminide (preferably with an intervening alumina layer)—the substrate may have a conventional form such as pellets or rings; in some embodiments the substrate is not an expanded metal sheet. As in the case of microchannel walls, preferred catalyst supports are preferably formed of a Ni—, Co—, or Fe-based superalloy.

A “porous catalyst material” (or “porous catalyst”) refers to a porous material (that may be an insert) having a pore volume of 5 to 98%, more preferably 30 to 95% of the total porous material's volume. At least 20% (more preferably at least 50%) of the material's pore volume is composed of pores in the size (diameter) range of 0.1 to 300 microns, more preferably 0.3 to 200 microns, and still more preferably 1 to 100 microns. Pore volume and pore size distribution are measured by Mercury porisimetry (assuming cylindrical geometry of the pores) and nitrogen adsorption. As is known, mercury porisimetry and nitrogen adsorption are complementary techniques with mercury porisimetry being more accurate for measuring large pore sizes (larger than 30 nm) and nitrogen adsorption more accurate for small pores (less than 50 nm). Pore sizes in the range of about 0.1 to 300 microns enable molecules to diffuse molecularly through the materials under most gas phase catalysis conditions. The porous material can itself be a catalyst, but more preferably the porous material comprises a metal, ceramic or composite support having a layer or layers of a catalyst material or materials deposited thereon. The porosity can be geometrically regular as in a honeycomb or parallel pore structure, or porosity may be geometrically tortuous or random. Preferably, a large pore support is a foam metal or foam ceramic. The catalyst layers, if present, are preferably also porous. The average pore size (volume average) of the catalyst layer(s) is preferably smaller than the average pore size of the support. The average pore sizes in the catalyst layer(s) disposed upon the support preferably ranges from 10⁻⁹ m to 10⁻⁷ m as measured by N₂ adsorption with BET method. More preferably, at least 50 volume % of the total pore volume is composed of pores in the size range of 10⁻⁹ m to 10⁻⁷ m in diameter.

Metal Aluminide Layer

In some embodiments of the invention, at least a portion of at least one interior wall of a microchannel apparatus (preferably a microreactor) is coated with a layer of a metal aluminide (preferably nickel aluminide (NiAl) or nickel platinum aluminide (Ni—Pt—Al)). It has been surprisingly discovered that an alumina wall coating formed by oxidizing a platinum aluminide (NiPtAl in the Example 3) coating provides superior coking resistance as compared to an alumina wall coating formed by oxidizing a nickel aluminide coating (Example 4), althouth the latter is still better than thermally grown oxide layer (grown from the substrate without forming an aluminide) or a solution deposited alumina layer. It is believed that exceptionally uniform coatings result from solid diffusion of the metal (Ni) to the surface where it reacts with aluminum and/or platinum. In addition, nickel may be plated onto a metal that is not rich in nickel, such as stainless steel, to create a reactive surface for the aluminization process. In a related aspect, a catalyst or catalyst intermediate can be formed on the surface either from alloy-derived nickel or nickel platinum that has been deposited before or concurrent with the aluminum. The invention also includes methods of making catalysts or microchannel apparatus comprising plating a substrate (preferably a Ni-based alloy) with platinum, heat treating the Pt-coated substrate, coating a the substrate (preferably a Ni-based alloy) with aluminum (typically chemical vapor deposited) that is simultaneously and/or subsequently converted to an aluminide (such as NiAl or Ni—Pt—Al).

Typically, the pt-aluminide will contain Ni or the principal element from the substrate by diffusion. Nickel platinum aluminide (Ni—Pt—Al) can be formed by first coating a nickel containing alloy with a coating of platinum by any of a wide range of techniques known to those skilled in the art, including, but not limited to, electroplating and electroless plating. The Pt coated alloy can be thermally treated by heating to 200 to 1200° C. in an inert atmosphere or in vacuo. The thermally treated Pt coated alloy is aluminized as described above or in any of many U.S. patents, such as U.S. Pat. No. 6,291,014, U.S. Pat. No. 5,856,027, or U.S. Pat. No. 5,716,720, which are incorporated herein by reference.

The nickel platinum aluminide surface that results can be heat treated in an oxidizing atmosphere to grow an alumina scale.

A NiAl layer can be formed by exposing a Ni-based alloy to AlCl₃ and H₂ at high temperature, preferably at least 700° C., in some embodiments 900 to 1200° C. Aluminum is deposted at the surface as a result of the reaction between AlCl₃ and H₂. At temperature, Ni from the substrate would diffuse towards the surface and react with the aluminum to form a surface layer of nickel aluminide. The Ni source could be Ni in a Ni-based alloy substrate, an electrolytically plated Ni layer, or a vapor deposited Ni layer that can be deposited over a substrate prior to aluminidization. It is believed that other metal aluminides (such as Co or Fe) could be formed under similar conditions.

Preferably the aluminidization is conducted with good control of flow to the device through a manifold, for example, good control can be obtained by passing flow into microchannels through a leak-free manifold that is integral to the microchannel device. Preferably the aluminidization process is carried out at 100 Torr (2 pounds per square inch absolute, psia) to 35 psia (1800 Torr), more preferably between 400 Torr (8 psia) and 25 psia (1300 Torr).

In preferred embodiments, nickel aluminide contains 13 to 32% aluminum, more preferably 20 to 32%; and still more preferably consists essentially of beta-NiAl.

In another preferred embodiment the nickel platinum aluminide contains at least 2% Al, preferably 5 to 25% aluminum (in some embodiments 10 to 25% aluminum), 5 to 70% (in some embodiments 8 to 55% Pt) platinum and the balance nickel.

In some embodiments, the metal aluminide layer has a thickness of 1 to 100 micrometers; in some embodiments a thickness of 5 to 50 micrometers. In some embodiments, the aluminide layer is completely oxidized; however, this is generally not preferred.

The metal surface upon which the metal aluminide is formed is preferably substantially free of oxides. Optionally the surface can be cleaned, polished, or otherwise treated to remove such oxides if any are present.

A reactor can be formed by a catalyst that is disposed as a coating on an internal wall (where the walls can be simple walls or shaped walls). Alternatively, or in addition, inserts such as fins, plates, wires, meshes, or foams can be inserted within a channel. These inserts can provide additional surface area and effect flow characteristics. An aluminization process can be used to fix inserts onto a wall of a device (such as a reactor); the resulting aluminum layer (or aluminum oxide, or aluminum, or metal aluminide, or a mixture of these) fills some voids and greatly improves thermal conduction between the insert and device wall (such as reactor wall).

Thermally Grown Oxide

Metal aluminide, is heated in the presence of oxygen or other oxidant to grow a layer of aluminum oxide. In some embodiments, oxygen is substantially excluded from the heat up step of the heat treatment process.

A convenient and preferred method of excluding oxygen from the surface while heating the surface from ambient temperature to treatment temperature involves exposure to hydrogen. The hydrogen effectively reduces the oxidizing power of the atmosphere during heat up to prevent premature growth of the oxide scale. Other gases that reduce the oxidizing power of the gas, such as NH3, CO, CH4, hydrocarbons, or the like, or some combination of these could also be used. All of these reducing gases could be used in combination with inert gases such as N2, He, Ar, or other inert gases, or combinations of inert gases.

In some embodiments, an oxide layer is formed by exposing the surface to an oxidizing atmosphere at or within 100° C. of the treatment temperature. The oxidizing gas could be air, diluted air, oxygen, CO2, steam or any mixture of these gases or other gases that have substantial oxidizing power, with or without an inert diluent. The inert diluent could be inert gases such as N2, He, Ar, or other inert gases, or a combination of inert gases. The temperature of oxide growth is at least 500° C., preferably at least 650° C. The surface can be exposed to the treatment condition in stages of different temperatures, different oxidizing powers, or both. For example, the surface could be treated at 650° C. for a time and then heated to 1000° C. and kept at 1000° C. for an additional time. Such controlled and staged surface treatment can generate a surface structure of a desired morphology, crystalline phase and composition.

It should be recognized that the term “alumina” can be used to refer to a material containing aluminum oxides in the presence of additional metals. In the descriptions herein, unless specified, the term “alumina” encompasses substantially pure material (“consists essentially of alumina”) and/or aluminum oxides containing modifiers.

Thinner layers are less prone to cracking; therefore, the thermally-grown oxide layer is preferably 5 μm thick or less, more preferably 1 μm thick or less, and in some embodiments is 0.1 μm to 0.5 μm thick. In some preferred embodiments, the articles have an oxide thickness of a thermally grown scale of less than 10 micrometers, and in some embodiments an oxide thickness of a thermally grown scale in the range of about 0.1 to about 5 micrometers. In some embodiments, thicker oxide layers may be useful, such as for a higher surface area catalyst support. In some preferred embodiments, the articles have an oxide thickness of a washcoat of less than 10 micrometers, and in some embodiments an oxide thickness of a washcoat in the range of about 1 to about 5 micrometers. Typically, these thicknesses are measured with an optical or electron microscope. Generally, the thermally-grown oxide layer can be visually identified; the underlying aluminide layer is metallic in nature and contains no more than 5 wt % oxygen atoms; surface washcoat layers may be distinguished from the thermally-grown oxide by differences in density, porosity or crystal phase.

The aluminized surface can be modified by the addition of alkaline earth elements (Be, Mg, Ca, Sr, Ba), rare earth elements (Y, La, Ce, Pr, Nd, Pm, Sm, Eu, Gd, Tb, Dy, Ho, Er, Tm, Yb, Lu) or combinations of these. The addition of these elements is followed by a reaction with an oxidizing atmosphere to form a mixed oxide scale. When the modifying element is La, for example, the scale contains LaAlOx, lanthanum aluminate. In some embodiments, a stabilized alumina surface can be formed by adding a rare earth element such as La, coated with a layer of alumina sol, then doped with an alkaline earth element such as Ca followed by a heat treatment.

Flow Rates

The aluminum-containing layer and alumina layers are preferably formed by reacting a surface with a gaseous reactant or reactants under dynamic flow conditions. The aluminum can be deposited in a microchannel by flowing AlCl₃ and H₂ into a microchannel. In a multichannel device, the Al can be deposited only on selected channels (such as by plugging certain channels to exclude the aluminum precursors during a CVD treatment). The aluminum can also be applied onto selected portions of a microchannel device by controlling relative pressures. For example, in a microchannel device that contains at least two channels separated by a wall and in which the two channels are connected to each other via orifices in the wall, AlCl₃ flows through a first channel while H₂, at a higher pressure, flows through a second channel and through the orifices into the first channel.

Static gas treatments can be conducted by filling the desired areas with the reactive gases with interim gas pumping if needed.
Wall Shear Stress: To ensure drag forces do not impair the formation of aluminization coating, the wall shear stress should not exceed 50 Pa if the aluminization gases are flowing through a jet orifice. Allowable wall shear stress should not exceed 200 Pa if the aluminization gases are not impinging on the wall of a microchannel as through a jet orifice.
Wall Dynamic Pressure: To ensure momentum impact erosion does not impair the adequate formation of aluminization coating, the wall dynamic pressure should not exceed 10 Pa if the aluminization gases are flowing through a jet orifice. Substantially higher wall dynamic pressure is allowed in the absence of a jet orifice. Allowable wall dynamic pressure should not exceed 100 Pa if the aluminization gases are not impinging on the wall of a microchannel as through a jet orifice.

Preferably, conditions are controlled to globally maintain the wall shear stress below 5×10⁻³ PSI and the wall dynamic pressure below 1×10⁻³ PSI throughout the entire device.

Masking

The aluminizing processes discussed above produce aluminide coatings throughout a channel. However, it is theoretically possible to selectively coat portions of a channel by masking off sections of a channel. This might be done by masking portions of a sheet with a refractory material and then laminating the masked sheet into a laminate. After aluminization the mask could be removed, such as by burning. Possible refractory materials might include Mo, diamond, and graphite. Masking techniques have been mentioned in U.S. Pat. No. 6,332,926.

Acid or Base Etch

Adhesion and/or surface area can be increased by an acid or base etch. Preferably this is conducted at moderate conditions on the thermally grown alumina layer. Severe conditions may result in excessive etching. Therefore, the (optional) etching step or steps are conducted at a pH of less than 5 (preferably 0 to 5) or greater than 8 (preferably 8 to 14).

Other Coating Modifications

Various other modifications can be used to enhance adhesion or other properties of alumina coatings over the alumina scale. An alumina coating can be deposited using an alumina sol or slurry.

In some preferred embodiments, instead of a single alumina coating, multiple alumina coatings are applied to the surface where at least two of the layers (more preferably at least 4 layers) have graded properties. For example, a first coat could be calcined at a first temperature (T1) and a subsequently deposited coat calcined at a lower second temperature (T2) resulting in graded coatings of increasing surface area. Other graded layers could be formed by: the graded use of water vapor during calcination; differing particle sizes in the coatings (smaller particles could be used for the first coat or coats thus increasing physical contact between the particles and the scale, while larger particles are present in later coats); and/or the graded use of stabilizers or binders (where the binders are subsequently burned out).

Additives such as rare earths or alkaline earth elements (including La, Ce and/or Pr) can increase hydrothermal stability of an alumina coating.

Catalyst Coatings

Catalysts can be applied using techniques that are known in the art. Impregnation with aqueous solutions of salts is preferred. Pt, Rh, and/or Pd are preferrred in some embodiments. Typically this is followed by heat treatment and activation steps as are known in the art. Salts which form solutions of pH>0 are preferred.

Reactions

The coated microchannel apparatus is especially useful when used with a surface catalyst or at elevated temperatures, for example, at temperatures above 500° C., in some embodiments 700° C. or higher, in some embodiments 900° C. or higher, or with both surface catalyst and elevated temperatures.

In some aspects, the invention provides a method of conducting a reaction, comprising: flowing at least one reactant into a microchannel, and reacting the at least one reactant in the presence of an optional catalyst within the microchannel to form at least one product. In some embodiments, the reaction consists essentially of a reaction selected from: acetylation, addition reactions, alkylation, dealkylation, hydrodealkylation, reductive alkylation, amination, ammoxidation, ammonia synthesis, aromatization, arylation, autothermal reforming, carbonylation, decarbonylation, reductive carbonylation, carboxylation, reductive carboxylation, reductive coupling, condensation, cracking, hydrocracking, cyclization, cyclooligomerization, dehalogenation, dimerization, epoxidation, esterification, exchange, Fischer-Tropsch, halogenation, hydrohalogenation, homologation, hydration, dehydration, hydrogenation, dehydrogenation, hydrocarboxylation, hydroformylation, hydrogenolysis, hydrometallation, hydrosilation, hydrolysis, hydrotreating (HDS/HDN), isomerization, methylation, demethylation, metathesis, nitration, polymerization, reduction, reformation, reverse water gas shift, Sabatier, sulfonation, telomerization, transesterification, trimerization, and water gas shift. Combustion is another preferred reaction. Hydrocarbon steam reforming is especially preferred (such as methane, ethane or propane steam reforming).

### EXAMPLES

To avoid oxide defects, care should be taken to avoid the use components that have surface oxides in the aluminidization process, especially surface oxides along the fluid pathway (that is, the pathway carrying aluminum compounds) leading to a microchannel device. In some preferred techniques, the tubing and/or other fluid pathways are subjected to a treatment to remove surface oxides (brightened), such as by a hydrogen treatment, KOH etching, electro-polishing or micro-brushing. Of course, before aluminidization, the microchannels may also be subjected to a treatment for the removal of surface oxide.

In preferred embodiments, the aluminide layer and the interfaces of the aluminide layer with the alloy substrate and an oxide layer (if present) is preferably substantially without voids or inclusions that are larger than 10 μm, more preferably substantially without voids or inclusions that are larger than 3 μm.

### Example 1

### Electroless Plating of Tube Internals with Pt

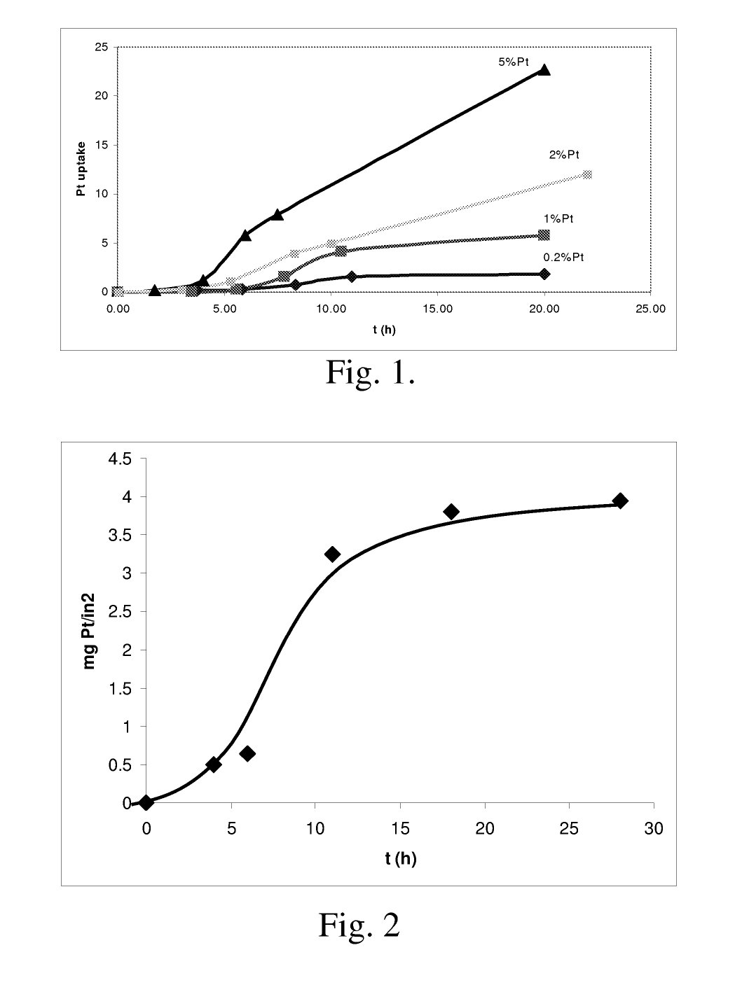

Stainless steel tubes have been used to demonstrate the effectiveness of electroless plating in coating internal surfaces of a channel with platinum. Tubes of ¼ inch and ⅛ inch outter diameter, 6 inches long have been used. Coating solution contains (NH3)4Pt(OH)2 and hydrazine in DI water, with the Pt metal to hydrazine ratio kept at 1:1 by weight. Plating was done at room temperature, by filling the tube with the solution and held static for a period of time. Multiple identical tubes were plated in parrallel, but terminated after different periods of time. After being rinsed with DI water and dried, the tubes were weighed and compared to the weights prior to the plating to deduce the platinum uptake. FIG. 1 gives the uptake by the ¼″ tubes as a function of time with solutions of different Pt concentrations. Note the uptake curves level off after ˜10 hr for 0.2 and 1% Pt solutions, suggesting depletion of the platinum precursor. The ¼″ tube has an inner diameter of 0.18 inch, so the length to ID ratio is 33 for the 6 inch long tubes. FIG. 2 gives the uptake curve with a 2% Pt solution on ⅛″ tubes. The ⅛″ tube has an inner diameter of 0.069 inch, so effective plating has been demonstrated with an aspect ratio of 87. An uptake of 4 mg/in2 is equivalent to a platinum coating of about 0.3 micron thick.

### Example 2

### Electroless Plating of a Microchannel Device

A microchannel device was used to demonstrate the effectiveness of electroless plating of platinum. The device has two microchannels in parallel, in communication via a series of small holes (0.016-0.050 inch in diameter) along the channel length. Channel A has a total length of 24 inches and a cross section of 0.160 inch by 0.050 inch. It is of a U design with each arm of the U being 12 inch long. Channel B has a length of 6 inch and a cross section of 0.160 inch by 0.050 inch. An access is provided at the U for introduction of solution for electroless plating.

Electroless plating was done by filling the channels with a solution of (NH3)4Pt(OH)2 (5 wt % Pt) and hydrazine (5 wt %) in DI water at room temperature, letting the solution sit in the device for 20 hours, and followed by draining, rinsing, drying and final calcination at 450 C for 4 hr. The device was then autopsied and examined by optical and electron microscopies. It was found for the portion of the channels filled with the solution, the channel walls were well coated with platinum of at least 1 micron in thickness. Coating appears to be uniform even at the U-turn and around the holes.

So the effectiveness of electroless Pt plating has been demonstrated on a microchannel device with a complex internal design and a channel length to channel gap ratio of about 150, allowing the making of a platinum-containing aluminide coating by using CVD aluminization. Methods for CVD aluminization of microchannel devices have been disclosed in U.S. patent application Ser. No. 11/088,685 filed on Mar. 23, 2005.

### Example 3

### Downstream: Pt-Aluminide

A Ni-aluminide coupon (0.12 in×0.33 in×1.5 in), a Ni-aluminide spacer coupon (0.12 in×0.33 in×4.25 in) and a Pt-aluminide spacer coupon (0.12 in×0.33 in×4.25 in) were heated to 1050° C. in flowing H₂ at 3.5° C./min heating rate. After purging with Ar for 1 hour at 1050° C., the gas was changed to 21% O₂/Ar. The coupons were heat-treated in flowing O₂/Ar for 10 hours and then cooled to room temperature. An α-Al₂O₃ scale was generated on the surface after the heat treatment.

A platinum catalyst was coated onto the coupon electrolessly as follows. The heat-treated Ni-aluminide coupon (0.12 in×0.33 in×1.5 in) was hung in 50 g Pt(NH₃)₄(OH)₂ solution containing 0.2 wt % Pt and 0.2 wt % N₂H₄H₂O. The pH was adjusted to 11 by acetic acid. The solution was stirred for 24 hours at room temperature. After that, the coupon was rinsed with water and dried with blowing air. The coupon was then put in a new Pt solution with the same composition and the plating process was repeated. The total Pt loading was 12 mg/in². The Pt plated coupon was calcined at 1000° C. in air for 4 hours.

The Pt plated coupon was then loaded in a single channel test reactor. The channel was separated into two microchannels by this coupon. The channel open gap was 0.020 inch. Upstream of the reactor was inserted a heat-treated Ni-aluminide spacer coupon (0.12 in×0.33 in×4.25 in). Downstream was inserted a heat-treated Pt-aluminide spacer coupon (0.12 in×0.33 in×4.25 in). Reactants were fed at 3:2:1 ratio of ethane:hydrogen:oxygen. Catalyst (coupon) entrance temperature ranged from 850 to 885° C., and contact time was fixed at 40 ms. Reaction products, e.g., CO, CO₂, and C1-C4 hydrocarbons, were analyzed with an on-line four-column gas chromatograph. At 850-885° C., ethane conversions were 71-82% and O₂ conversions were 95-97%. Ethylene selectivities were 75-77%. The other major by-products were CO (˜12%), CH₄ (˜8%), C₂H₂ (0.6-1.5%) and C₃H₆ (1.5-2%). There was no measureable pressure drop increase during the 5-hour testing. After the testing, the device was opened and only a trace amount of coke was found at the Pt-aluminide spacer coupon downstream where the temperature during testing was around 550° C. No coke was observed in areas of the coupon where temperatures exceeded about 600° C.

### Example 4

### Downstream: Ni-Aluminide

A Ni-aluminide coupon (0.12 in×0.33 in×1.5 in) and two Ni-aluminide spacer coupons (0.12 in×0.33 in×4.25 in) were heated to 1050° C. in flowing H₂ at 3.5° C./min heating rate. After purging with Ar for 1 hour at 1050° C., the gas was changed to 21% O₂/Ar. The coupons were heat-treated in flowing O₂/Ar for 10 hours and then cooled to room temperature. An α-Al₂O₃ scale was generated on the surface after the heat treatment.

A platinum catalyst was coated onto the coupon electrolessly as follows. The heat-treated Ni-aluminide coupon (0.12 in×0.33 in×1.5 in) was washcoated with 10 wt % La(NO₃)₃.6H₂O+1 wt % polyvinyl alcohol (M.W.: 11,000-31,000) solution first. After drying at room temperature, the coupon was calcined at 1000° C. for 4 hours in air. The weight gain after calcination was 0.5 mg/in². The La₂O₃-coated coupon was then hung in 50 g Pt(NH₃)₄(OH)₂ solution containing 0.2 wt % Pt and 0.2 wt % N₂H₄H₂O. The solution was stirred for 8 hours at room temperature. After that, the coupon was rinsed with water and dried with blowing air. The coupon was then put in a new Pt solution with the same composition for 1.5 hours. The total Pt loading was 11 mg/in². The Pt plated coupon was calcined at 1000° C. in air for 4 hours.

The Pt plated coupon was then loaded in a single channel testing reactor. The channel was separated into two microchannels by this coupon. The channel open gap was 0.020 inch. Upstream and downstream of the reactor were inserted heat-treated Ni-aluminide spacer coupons (0.12 in×0.33 in×4.25 in). Reactants were fed at 3:2:1 ratio of ethane:hydrogen:oxygen. Catalyst (coupon) entrance temperature ranged from 875 to 910° C., and contact time was fixed at 40 ms. Reaction products, e.g., CO, CO₂, and C1-C4 hydrocarbons, were analyzed with an on-line four-column gas chromatograph.

At 875-910° C., ethane conversions were 65-82% and O₂ conversions were 98.5-99%. Ethylene selectivities were 79-82%. The other major by-products were CO (8-9%), CO₂ (1.6-2%), CH₄ (6-7.5%), C₂H₂ (0.4-2%) and C₃H₆ (0.8%). Pressure drop was increased from 0.27 to 0.82 psi during the 5-hour testing. After the testing, the device was opened and a significant amount of coke was found at the Ni-aluminide spacer coupon downstream where the temperature during testing was between 950 and 550° C.

We claim:

1. A microchannel reactor or separator, comprising:
a microchannel defined by at least one microchannel wall; and
a layer of platinum aluminide disposed over the at least one microchannel wall.

2. The reactor or separator of claim 1 further comprising a layer of alumina disposed over the layer of aluminide; and
a catalytic or sorbent material disposed over the layer of alumina.

3. The reactor or separator of claim 1 wherein the microchannel comprises at least one complex microchannel having at least one angle of at least 45°.

4. The reactor or separator of claim 1 comprising a manifold that is connected to at least two microchannels, wherein the manifold comprises a manifold wall that is coated with a platinum aluminide layer.

5. The reactor or separator of claim 1, wherein the layer of platinum aluminide is a post-assembly coating and further wherein the reactor or separator is made by laminating together sheets.

6. The reactor or separator of claim 1, wherein the layer of platinum aluminide is a post-assembly coating and the platinum is coated by electroless plating.

7. A method of conducting a chemical reaction or separating a mixture in the reactor or separator of claim 1, comprising either:
(a) wherein the reactor or separator is a reactor and further comprising a step of passing a reactant into the microchannel and reacting the reactant in the microchannel to form at least one product; or
(b) wherein the reactor or separator is a separator and comprising a step of passing a fluid comprising at least two components into the microchannel, preferentially separating at least one of the at least two components within the microchannel.

8. The microchannel reactor or separator of claim 2, wherein the layer of platinum aluminide is a post-assembly coating of platinum aluminide disposed over the at least one microchannel wall.

9. The microchannel reactor or separator of claim 2, wherein the layer of platinum aluminide is a post-assembly coating and the platinum is coated by electroless plating.

10. The microchannel reactor or separator of claim 8 made by stacking patterned sheets to form a stacked set of patterned sheets with interior passages;
bonding the set of patterned sheets to form a laminated device; and
subsequently, applying a layer comprising Pt into interior passages of the laminated device.

11. The microchannel reactor or separator of claim 1 comprising at least two parallel microchannels connected to a manifold, wherein each of the at least two parallel microchannels comprise at least one microchannel wall; and
a post-assembly coating of aluminide disposed over the at least one microchannel wall.

12. A method of conducting a chemical reaction in the microchannel reactor or separator of claim 1, comprising:
wherein the reactor or separator is a reactor and the reactor further comprises a a catalytic material disposed over the layer of alumina, and comprising a step of passing a reactant into the complex microchannel and reacting the reactant in the microchannel to form at least one product.

13. Microchannel apparatus, comprising:
at least two parallel microchannels, each of which is contiguous for at least 1 cm;
a manifold connecting the at least two microchannels;
wherein the manifold comprises a platinum aluminide coating.

14. A method of forming a microchannel reactor or separator, comprising:
stacking patterned sheets to form a stacked set of patterned sheets with interior passages;
bonding the set of patterned sheets to form a laminated device; and
subsequently, applying a layer comprising Pt into interior passages of the laminated device;
simultaneous with, or subsequent to, the step of applying a layer comprising Pt, depositing aluminum to form a layer of platinum aluminide.

15. The method of claim 14 wherein Pt is applied electrolessly into the interior passages.

16. The method of claim 14 comprising a step of heating to at least 800° C. that occurs simultaneous with, or subsequent to, the step of depositing aluminum.

17. The method of claim 7 wherein the reactor or separator is a reactor and the reactor further comprises a layer of alumina disposed over the layer of platinum aluminide; and a catalytic material disposed over the layer of alumina, and comprising a step of passing a reactant into the microchannel and reacting the reactant in the microchannel to form at least one product.

18. The method of claim 7 wherein the reactor or separator is a reactor and wherein the reactant comprises a hydrocarbon.

19. The method of claim 12 comprising hydrocarbon steam reforming.

20. The method of claim 12 comprising combustion in the microchannel, and further wherein the reactor comprises a channel adjacent to the microchannel, wherein an endothermic reaction is occurring in the adjacent channel; and wherein heat is transferred from the combustion to the endothermic reaction occurring in the adjacent channel.

21. The method of claim 20 wherein essentially no coke forms in the microchannel.

22. The method of claim 20 wherein the adjacent channel is a microchannel.
